(19) United States
(12) Patent Application Publication
(10) Pub. No.: US 2002/0002061 A1
(43) Pub. Date: Jan. 3, 2002

(54) Electronic apparatus

(75) Inventors: Toshiki Miyasaka, Urawa-shi (JP); Fumiyoshi Tezuka, Ome-shi (JP)

Correspondence Address: Finnegan, Henderson, Farabow,, Garrett & Dunner, L.L.P., 1300 I Street, N.W., Washington, DC, 20005-3315, US

(73) Assignee: Kabushiki Kaisha Toshiba

(21) Appl. No.: 09/800,889

(22) Filed: Mar. 8, 2001

(30) Foreign Application Priority Data
May 26, 2000 (JP) 2000-157015

(51) Int. Cl. H04M 1/00

(52) U.S. Cl. 455/557; 455/558; 455/41

(57) ABSTRACT

An apparatus body has a metal plate and a holding portion detachably loaded with a PC card that includes an antenna. The holding portion is provided at the metal plate. The apparatus body is provided with a connecting portion for data communication with the PC card therein. The holding portion is arranged to hold the PC card in a manner such that the antenna is exposed outside of the holding portion and the minimum distance between the antenna and the metal plate is 1 mm or more.

### CROSS-REFERENCE TO RELATED APPLICATIONS

This application is based upon and claims the benefit of priority from the prior Japanese Patent Application No. 2000-157015, filed May 26, 2000, the entire contents of which are incorporated herein by reference.

### BACKGROUND OF THE INVENTION

The present invention relates to an electronic apparatus, and more particularly, to an electronic apparatus capable of radio data communication with some other electronic apparatuses using a radio communication card.

When a personal computer is used for internet connection, in general, a modem that is attached to the computer and a modular jack of a public data network in a general home are connected to each other by means of a modular cable. When using this modular cable, however, the connection and wire arrangement are troublesome. If the personal computer and the modular jack are remote from each other, they cannot be connected with ease. Accordingly, the place of installation of the personal computer cannot be selected freely.

This problem of connection can be solved by a current prevailing radio communication connecting apparatus that utilizes radio communication for connection without using any modular cable. This radio communication connecting apparatus is connected to the public data network by means of a modular cable, and data are transmitted between the personal computer and the connecting apparatus by radio communication, whereby the computer and the network are connected to each other. With use of this connecting apparatus, troublesome connection and arrangement of the modular cable can be eliminated, the place of installation of the personal computer can be selected freely, and the range of service can be extended.

In some cases, however, the radio communication connecting apparatus of this type may not be able to be used, depending on various conditions, such as the function and design, the type of the corresponding personal computer, OS, and line, expansibility, etc. that vary according to products.

### BRIEF SUMMARY OF THE INVENTION

Accordingly, the object of the present invention is to provide a highly versatile electronic apparatus, capable of radio communication with some other electronic apparatuses using a radio communication card and of being wirelessly connected or linked to various apparatuses with ease.

In order to achieve the above object, an electronic apparatus according to the present invention comprises: a holding portion for detachably holding a radio communication card including an antenna; a metal plate on which the holding portion is provided; and a connecting portion for data communication with the radio communication card held by the holding portion. The holding portion is arranged to hold the radio communication card in a manner such that the antenna is exposed outside of the holding portion and the minimum distance between the antenna and the metal plate is 1 mm or more.

According to the electronic apparatus constructed in this manner, the radio communication card can be used for radio communication between some electronic apparatuses. This electronic apparatus is a highly versatile apparatus that can be wirelessly connected or linked to various other apparatuses with ease. Further, the distance between the antenna and an end portion of a metal plate of the apparatus body is 1 mm or more, and preferably, 2 mm or more. In this case, the metal plate can be prevented from intercepting or attenuating the radio waves, so that steady data communication can be ensured.

An electronic apparatus according to the present invention comprises: an apparatus body having an installation surface and a first surface opposite to the installation surface; a holding portion provided at the apparatus body, for detachably holding a radio communication card which has a second surface and an antenna provided on the second surface; and a connecting portion arranged at the apparatus body, for data communication with the radio communication card held by the holding portion. The holding portion is arranged to hold the radio communication card in a manner such that the first and second surfaces face in the same direction.

Further, an electronic apparatus according to the present invention comprises: an apparatus body having an installation surface and a holding portion for detachably holding a radio communication card including an antenna; and a connecting portion provided at the apparatus body, for data communication with the radio communication card held by the holding portion. The holding portion is arranged to holding the radio communication card in a manner such that the antenna is exposed outside of the apparatus body and situated farther from the installation surface of the apparatus body than a center of the apparatus body with respect to the height direction of the apparatus body.

According to the electronic apparatus constructed in this manner, the radio communication card can be used for radio communication between some electronic apparatuses. This electronic apparatus is a highly versatile apparatus that can be wirelessly connected or linked to various other apparatuses with ease. Further, the antenna of the radio communication card can be kept off the installation surface, so that influences of a floor or wall surface upon radio waves can be reduced, and steady data communication can be ensured.

Another electronic apparatus according to the invention comprises a removable cover that covers the holding portion and the radio communication card set in the holding portion. Further, the cover is formed in a manner such that the attachment of the radio communication card can be visually recognized from the outside. According to this arrangement, the cover can prevent dirt, dust, etc. from getting into the holding portion. Since the inside of the holding portion can be visually observed through the cover, moreover, the attachment of the radio communication card can be easily recognized, so that wrong operation can be prevented.

Still another electronic apparatus according to the invention comprises a slide switch; a rotary switch; and setting means for setting operating states of the apparatus in accordance with combinations of shift positions of the slide and rotary switches. Since the operating modes are set by means of combinations of the slide and rotary switches only, the operating efficiency can be improved, and the switches can be reduced in number so that the apparatus is miniaturized and its manufacturing cost is lowered.

A further electronic apparatus according to the invention uses a PC card as the radio communication card. With use of the standardized PC card as a radio communication module, the apparatus is highly versatile, and can be wirelessly connected or linked to various other apparatuses with ease.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a perspective view schematically showing an outline of a radio communication system with an access point according to an embodiment of the present invention;

FIG. 2 is an exploded perspective view showing the access point, a BT-PC card, and a cover;

FIG. 3 is a perspective view showing the access point in its vertical position;

FIG. 4 is a perspective view showing the rear side of the access point;

FIG. 5 is a perspective view showing the access point in its horizontal position;

FIG. 6 is a perspective view showing the bottom side of the access point;

FIG. 7 is a perspective view showing the BT-PC card;

FIG. 8 is an exploded perspective view showing the BT-PC card;

FIG. 9 is an exploded perspective view showing the internal structure of the access point;

FIG. 10 is a perspective view showing a card slot of the access point;

FIG. 11 is a perspective view showing a connecting portion between the BT-PC card and a connector on the card-slot side;

FIG. 12 is a front view showing the BT-PC card set in position;

FIG. 13 is a diagram showing the relationship between the minimum distance d and an attenuate level of the radio wave output;

FIG. 14 is a front view showing the access point in its horizontal position;

FIG. 15 is a block diagram schematically showing the respective configurations of the access point and the BT-PC card;

FIG. 16 is a block diagram schematically showing the respective configurations of the BT-PC card and a personal computer for data communication with the access point; and

FIG. 17 is a table showing assignment of switch shift positions of the access point to operating states.

### DETAILED DESCRIPTION OF THE INVENTION

An electronic apparatus (hereinafter referred to as access point) for radio communication connection according to an embodiment of the present invention will now be described in detail with reference to the accompanying drawings.

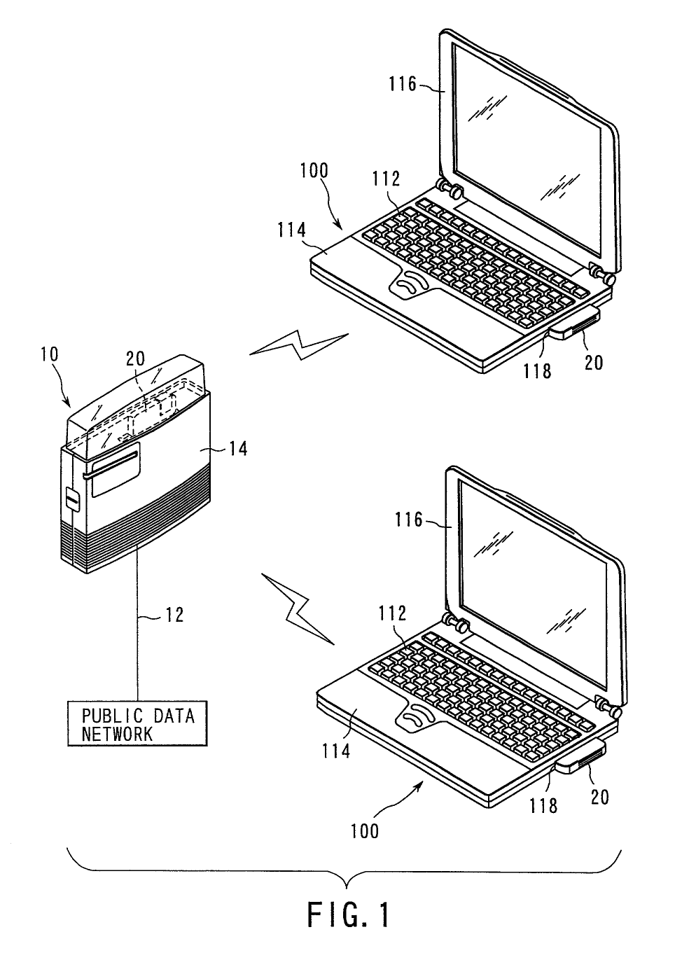

FIG. 1 shows a system for radio communication between an access point 10 according to the present embodiment and two personal computers 100. The access point 10 and each personal computer 100 are each detachably fitted with a PC card (hereinafter referred to as BT-PC card) 20 based on the radio communication standards called Bluetooth (hereinafter referred to as BT), for use as a radio communication card, which will be mentioned later. The access point 10, which is connected to a public data network by means of a modular cable 12, transfers data wirelessly transmitted from the personal computers 100 to the public data network and wirelessly transmits data from the public data network to the personal computers by utilizing the BT-PC card 20.

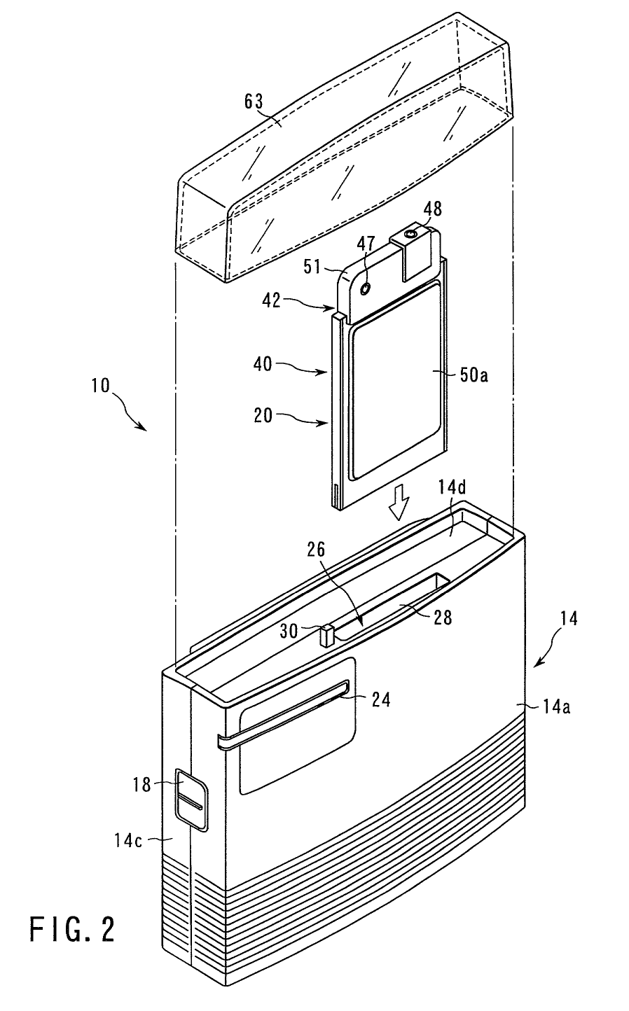

As shown in FIGS. 2 to 6, the access point 10 is provided with a substantially rectangular apparatus body 14 that is formed of, for example, a synthetic resin. The apparatus body 14 has a slightly curved front face 14a, a substantially flat back face 14b opposed to the front face, a pair of opposite side faces 14c, a top face 14d, and a bottom face 14e. The bottom and back faces 14e and 14b of the apparatus body 14 constitute first and second installation surfaces, respectively.

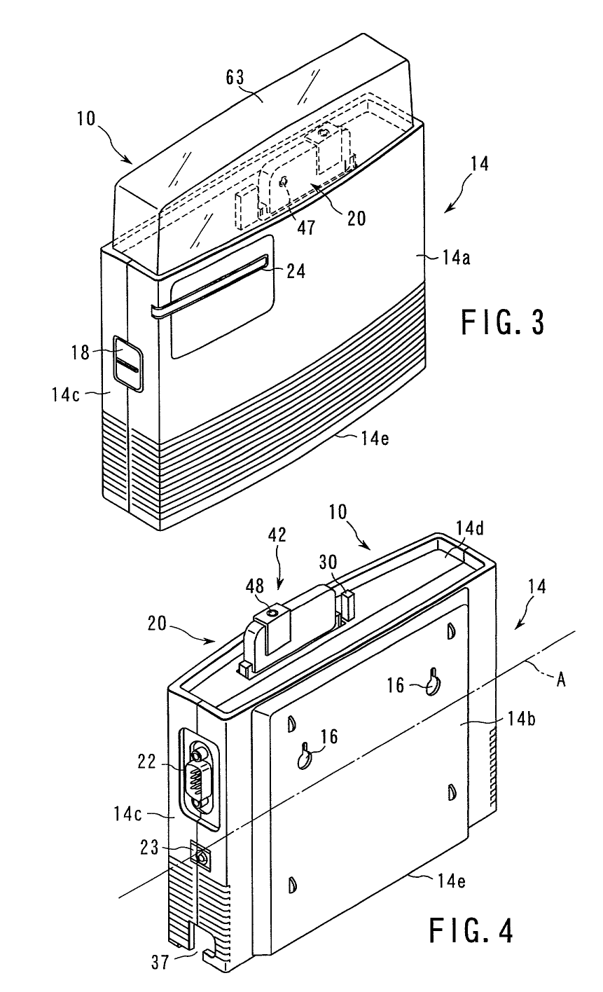

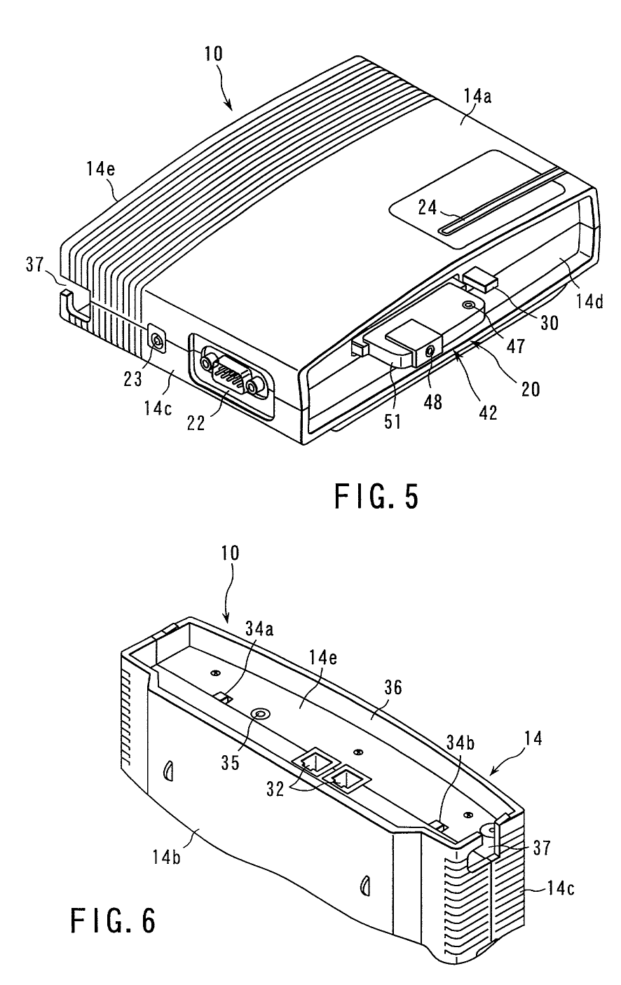

The apparatus body 14 of the access point 10 can be used in a vertical position such that the bottom face 14e is put on the top of a desk or the like, as shown in FIGS. 3 and 4. Alternatively, it can be used in a horizontal position such that the back face 14b is put on the top of a desk or the like, as shown in FIG. 5. The back face 14b is formed having two engaging recesses 16 for pins, hooks, etc. By using these engaging recesses 16, the apparatus body 14 can be also used as of a wall-mounted type such that its back face is opposed to a wall.

A power switch 18 of a push-button type is provided on the one side face 14c of the apparatus body 14. An RS232C connector 22 and an AC adapter terminal 23 for power connection are arranged on the other side face 14c. Further, a plurality of LED's 24 for use as display elements that indicate operating states of the access point 10 are arranged side by side on the front face 14a of the apparatus body 14. The operating states include, for example, a power-on state (POWER), sending state (SD), receiving state (RD), off-hook state (OH), standby/active state (STB/ACT) of the BT-PC card 20 (mentioned later), etc.

The top face 14d of the apparatus body 14 is provided with a card loading aperture 28 of a card slot 26 (mentioned later) and an ejector button 30. As seen from FIG. 6, moreover, the bottom face 14e is provided with two modular jacks 32, which can be connected with the modular cable 12 for connecting the access point 10 to the public data network, a pair of slide switches 34a and 34b, left and right, and a rotary switch 35.

A skirt portion 36 is set up along the peripheral edge portion of the bottom face 14e, and a notch 37 is formed in a part of the skirt portion 36. The skirt portion 36 serves as a leg portion when the apparatus body 14 is used in the vertical position. The modular cable 12 that is connected to the modular jacks 32 is drawn out through the notch 37. Even in the case where the apparatus body 14 is used in the vertical position with the modular cable 12 connected to the modular jacks 32, therefore, the apparatus body 14 can be steadily supported by means of the skirt portion 36 without being hindered by the modular cable.

The card slot 26 for use as a holding portion is located in the apparatus body 14. The card loading aperture 28 of the card slot 26 opens in the top face 14d of the apparatus body. The BT-PC card 20 can be detachably fitted to the card slot 26 through the card loading aperture 28.

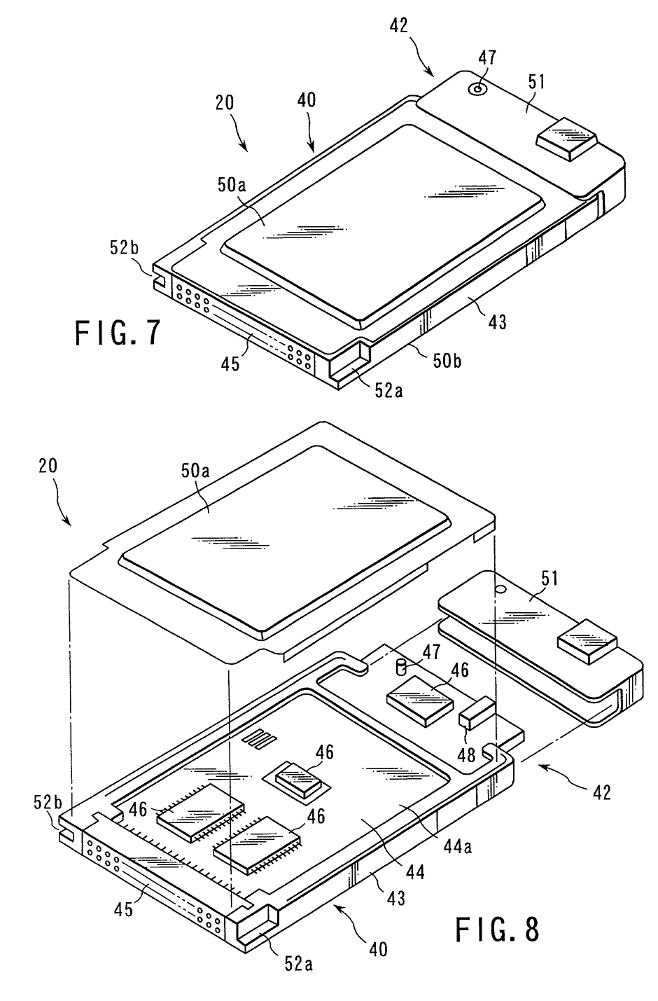

The following is a detailed description of the BT-PC card 20 and the card slot 26. As shown in FIGS. 7 and 8, the BT-PC card 20 includes a card body 40 based on the PCMCIA standards, and an a transmitter-receiver portion 42 protruding from one end of the card body and based on the BT standards. The card body 40 has a substantially rectangular plastic frame 43, which supports the peripheral edge portion of a rectangular card substrate 44. A connector 45 is attached to one end of the card substrate 44, and the other end portion of the card substrate projects from the card body 40.

A plurality of electronic components 46 are mounted on one surface of the card substrate 44, that is, an upper surface 44a in this case. Arranged on the upper surface of the other end portion of the card substrate 44, moreover, are an antenna element 46, an LED 47 that glows when signals are transmitted or received, and a headset portion 48 to be connected with a headphone, microphone, etc. which constitute the transmitter-receiver portion 42

The upper and lower surfaces of the card substrate 44, except the other end portions thereof, are covered, respectively, by means of a pair of metallic covers 50a and 50b that are fitted on the frame 43. Further, the transmitter-receiver portion 42 has a plastic cap 51, which is fitted on the other end of the card body 40 and covers the other end portion of the card substrate 44 and the antenna element 46, LED 47, and headset portion 48 that are mounted on the upper surface of the other end portion of the substrate 44.

The end of the BT-PC card 20 to which the connector 45 is attached is a loading-side end for the card slot 26. The front end of one side wall of the frame 43 is formed having a first guide groove 52a, which opens in the top face, one side face, and front end face of the card body 40. The front end of the other side wall of the frame 43 is formed having a second guide groove 52b, which opens only in the other side face and front end face of the card body 40. As mentioned later, the first and second guide grooves 52a and 52b serve to regulate the facing of the BT-PC card 20 as the card 20 is loaded into the card slot 26.

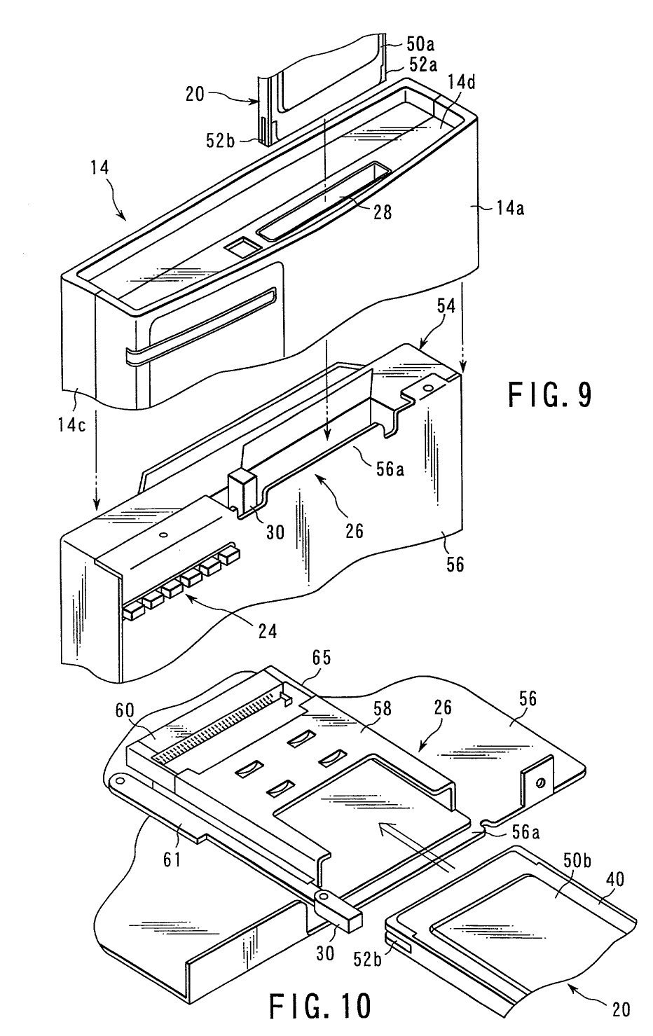

As shown in FIGS. 9 and 10, on the other hand, a metallic frame 54 is provided in the apparatus body 14. The frame 54 is fitted with the aforesaid power switch 18, RS232C connector 22, AC adapter terminal 23, etc. and various electronic components mentioned later. The metallic frame 54 includes a substantially flat shielding plate 56 that is situated adjacent and opposite the front face 14a of the apparatus body 14. A top center portion 56a of the shielding plate 56 extends close to the card loading aperture 28. The card slot 26 is located inside the shielding plate 56.

The card slot 26 includes a metallic holding frame 58 that is fixed to the shielding plate 56. The frame 58 is shaped and sized corresponding to the card body 40 of the BT-PC card 20 and opposed to the card loading aperture 28. Further, the card slot 26 includes a connector 60 on the tail end portion of the holding frame 58 and an ejector lever 61 on a side portion of the frame 58. The ejector button 30 is coupled to the lever 61. The connector 60 constitutes a terminal portion according to the present invention.

If the BT-PC card 20 is inserted into the card slot 26 through the card loading aperture 28, it is guided by the holding frame 58 so that its connector 45 is connected to the connector 60 of the card slot. The card body 40 of the BT-PC card 20 is held in the card slot 26 by means of the holding frame 58 and the connectors 45 and 60 that are connected to each other, and is connected electrically to the access point 10.

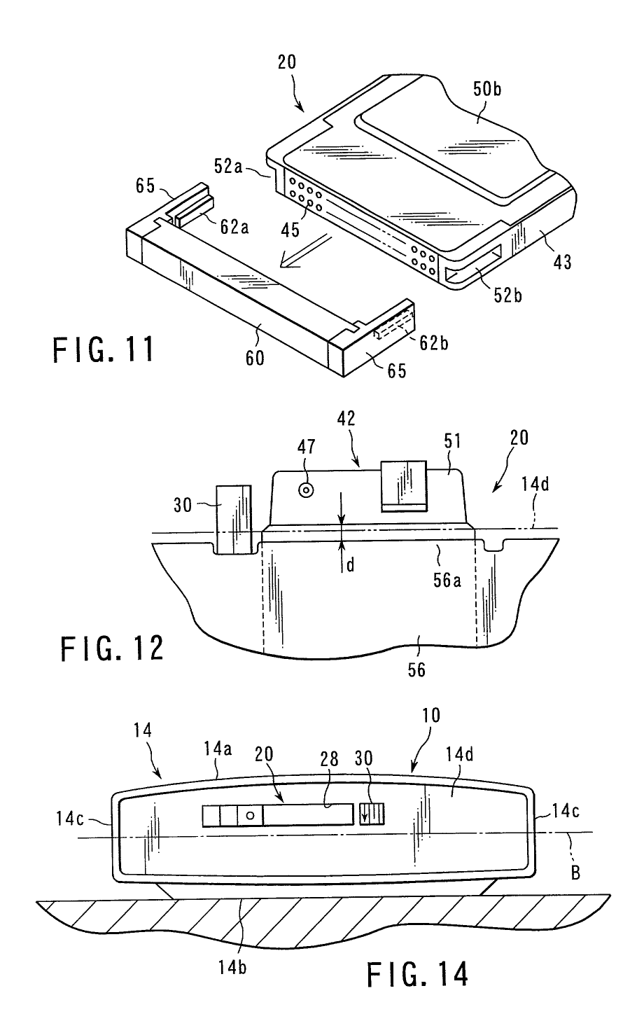

As shown in FIG. 11, plastic guide frames 65 are provided individually on the opposite end portions of the connector 60. The frames 65 are formed having first and second guide projections 62a and 62b corresponding to the first and second guide grooves 52a and 52b of the BT-PC card 20, respectively. More specifically, the first guide projection 62a is shaped and positioned so that it can engage only the first guide groove 52a of the BT-PC card 20, while the second guide projection 62b is shaped and positioned so that it can engage only the second guide groove 52b of the card 20.

Thus, the first and second guide grooves 52a and 52b can engage the first and second guide projections 62a and 62b of the card slot 26, respectively, to set the BT-PC card 20 in a given position only when the card 20 is inserted into the slot 26 in a manner such that the grooves 52a and 52b are opposed to their corresponding projections 62a and 62b, that is, the upper surface (on the side of the metallic cover 50a) of the card 20 faces the front face 14a of the apparatus body 14.

If the BT-PC card 20 is inserted inside out into the card slot 26, the first and second guide grooves 52a and 52b never engage their corresponding guide projections 62a and 62b, so that attachment is restrained, that is, wrong attachment can be prevented. In removing the BT-PC card 20, the ejector button 30 is depressed so that the ejector lever 61 presses the distal end face of the card 20. In consequence, the connectors 45 and 60 are disconnected from each other, and the card body 40 is pushed out toward the card loading aperture 28, whereupon the removal of the card 20 is allowed.

When the BT-PC card 20 is set in the card slot 26, only the card body 40 is held in the card slot, and the transmitter-receiver portion 42 is left exposed to the outside, as shown in FIG. 5, for example. Further, the card slot 26 is designed so that a minimum distance d between the top center portion 56a of the shielding plate 56 on the side of the apparatus body 14 and the transmitter-receiver portion 42 of the BT-PC card 20 is 1 mm or more, and preferably, 2 mm or more, with the card 20 set in position, as shown in FIG. 12.

In this set state, the transmitter-receiver portion 42 of the BT-PC card 20 is exposed, the minimum distance d from the shielding plate 56 is adjusted to 1 mm or more. By doing this, steady data communication can be effected without allowing the apparatus body 14 or shielding plate 56 to intercept or attenuate radio waves during data transmission or reception.

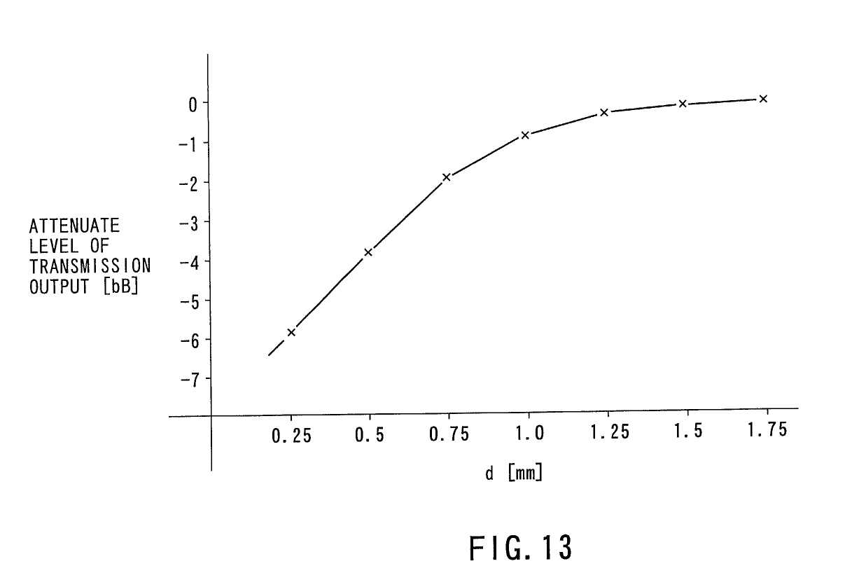

FIG. 13 shows the relationship between the distance d and an attenuate level of the radio wave output. As clearly understood from FIG. 13, if the minimum distance d is adjusted to 1 mm or more, intercept and attenuate of radio waves by the shielding plate 56 can be prevented.

Further, the card slot 26 is designed so that the transmitter-receiver portion 42 of the BT-PC card 20, especially the antenna element 46, is located eccentrically to the installation surface and situated above a central position in the height direction of the apparatus body 14 without regard to the working position, vertical or horizontal, of the apparatus body when the card 20 is set in position.

More specifically, in the case where the apparatus body 14 is used in its vertical position with its bottom face 14e serving as the installation surface, as shown in FIG. 4, the transmitter-receiver portion 42 of the BT-PC card 20 in the card slot 26 is situated above a center line A in the height direction of the apparatus body, that is, in the direction perpendicular to the installation surface. In the case where the apparatus body 14 is used in its horizontal position with its back face 14b serving as the installation surface, as shown in FIG. 14, the transmitter-receiver portion 42 of the BT-PC card 20 is situated farther from the installation surface than a center line B in the height direction of the apparatus body that is perpendicular to the installation surface is, that is, above the center line B.

Thus, the antenna element 46 of the BT-PC card 20 can be located off a desk top, wall, or the like without regard to the working position, vertical or horizontal, of the apparatus body, so that bad influences of the desk top or wall upon the radio waves that are transferred through the antenna element 46 can be lessened. At the same time, the BT-PC card 20 can be loaded into the card slot 26 only when its upper surface or the upper surface 44a of card substrate 44 on which the antenna element 46 is mounted faces the front face 14a of the apparatus body 14, as mentioned before. In the case where the apparatus body 14 is used in the horizontal position shown in FIG. 14, the antenna element 46 is always situated on the side remoter from the installation surface. Accordingly, the bad influences of the desk top or wall upon the radio waves can be further lessened. Thus, steadier data communication can be ensured.

In the case where the apparatus body 14 is used in the vertical position, the top face 14d that has the card loading aperture 28 extends substantially parallel to the bottom face 14e that serves as the installation surface, so that dirt, dust, etc. may possibly get into the apparatus body through the aperture 28. As shown in FIGS. 2 and 3, therefore, the access point 10 is provided with a cover 63 that can be removably fitted on the top face 14d of the apparatus body 14. The cover 63 is formed of a nonmetallic material that transmits light, e.g., a transparent resin. In the case where the apparatus body 14 is used in the vertical position, the cover 63 on its top face 14d serves to cover the card loading aperture 28 of the card slot 26 and the BT-PC card 20 therein, thereby preventing dirt, dust, etc. from getting into the apparatus body.

Since the cover 63 transmits light, moreover, the attachment of the BT-PC card 20 can be externally visually recognized with ease, and the glowing state or active state of the LED 47 on the card 20 can be visually recognize from the outside.

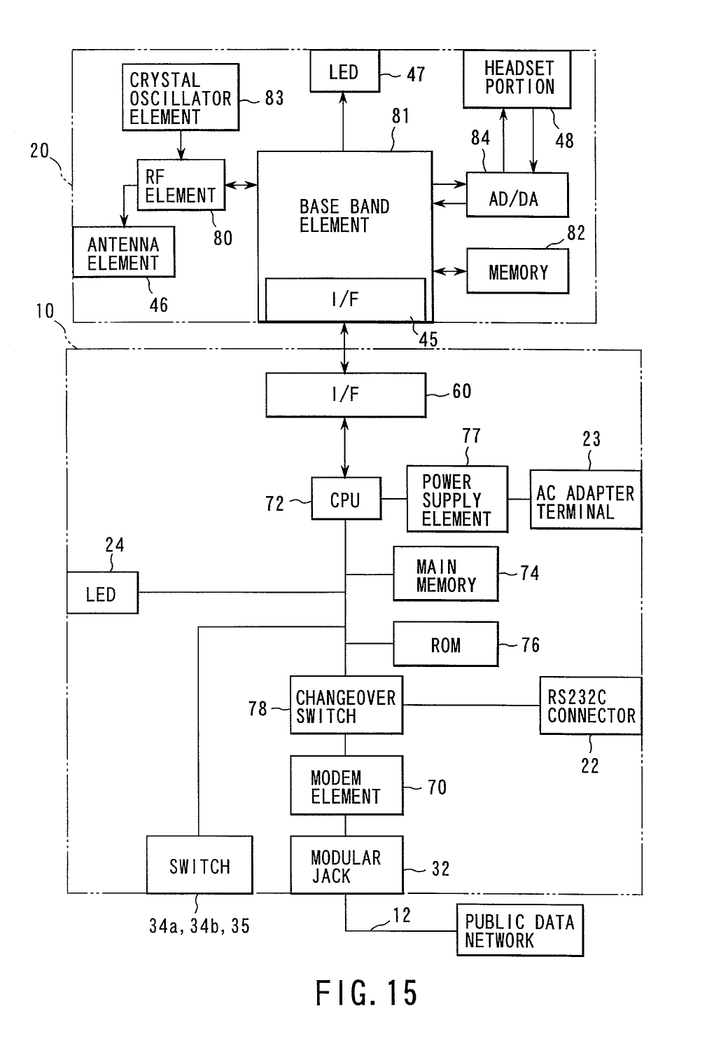

The following is a description of the respective internal structures of the access point 10 and the BT-PC card 20 described above. As shown in FIG. 15, the access point 10 includes a CPU 72 for controlling the operation of the entire access point. The CPU 72 is connected with the LED's 24, slide switches 34a and 34b, rotary switch 35, and connector 60 as an interface connector. A main memory 74 and a ROM 76 are connected to the CPU 72 by means of a memory bus, and power supplied from the AC adapter terminal 23 is supplied to the CPU through a power supply element 77. The CPU 72 functions also as setting means according to this invention.

Further, the access point 10 includes a modem element 70 that is connected to the public data network by means of the modular cable 12 and the modular jack 32. The modem element 70 and the RS232C connector 22 are connected to the CPU 72 through a changeover switch 78. The modem element 70 and the ejector button 30 function as a transmitter-receiver portion.

The main memory 74, which is composed of a plurality of DRAM's, is a memory device that is loaded with driver software including operating programs for the access point 10, a device driver, and a radio communication protocol. The ROM 76 is loaded with communication protocols for radio communication and the public data network.

The modem element 70 converts digital data received from the BT-PC card 20 into analog data, transfers the data to the public data network through the modular jack 32, converts the analog data received from the public data network through the modular jack 32 into digital data, and transfers the data to the CPU 72.

The RS232C connector 22 is provided for the serial connection between the access point 10 and other electronic apparatuses such as the personal computers 100 by means of a RS232C cable (not shown). For example, an ISDN terminal adapter may be connected to the access point 10 by means of the RS232C connector 22 and the RS232C cable so that the digital data received from the BT-PC card 20 can be transferred directly. Further, the access point 10 and the personal computers 100 may be connected to one another by means of the RS232C connector 22 and the RS232C cable so that the operating states (mentioned later) of the access point 10 can be set by means of the personal computers.

The changeover switch 78 serves for switching between the connection with the public data network by means of the modem element 70 and the modular jack 32 and the connection with the other electronic apparatus by means of the RS232C connector 22.

On the other hand, the BT-PC card 20, as a radio module based on the BT standards, comprises the antenna element 46, an RF element 80, a base band element 81, a memory 82, a crystal oscillator element 83, the headset portion 48, an AD/DA converter element 84, and the LED 47.

The connector 45 as an interface connector is used for data transfer between the BT-PC card 20 and the access point 10. The antenna element 46 transmits and receives radio waves to execute radio communication, and its working frequency band ranges from 2.4 to 2.5 GHz. The RF element 80 carries out signal processing such that communication can be executed with given working radio frequencies.

The base band element 81 digitally processes data inputted through the antenna element 46 and the RF element 80, converts them into data that can be processed in the access point 10 and loads them into the memory 82. The data are transferred to and from the access point. The LED 47 glows when the data are transmitted or received, for example. The memory 82 is loaded with a radio protocol.

The crystal oscillator element 83 supplies reference waves that are used in the RF element 80. The headset portion 48 is connected with a headset that includes the headphone and the microphone, and inputs and outputs aural signals. Further, the AD/DA converter element 84 converts analog data received from the headset portion 48 into digital data signals, converts digital data that are received from the access point 10 through the base band element 81 into analog signals, and transmits the analog signals to the headset portion 48.

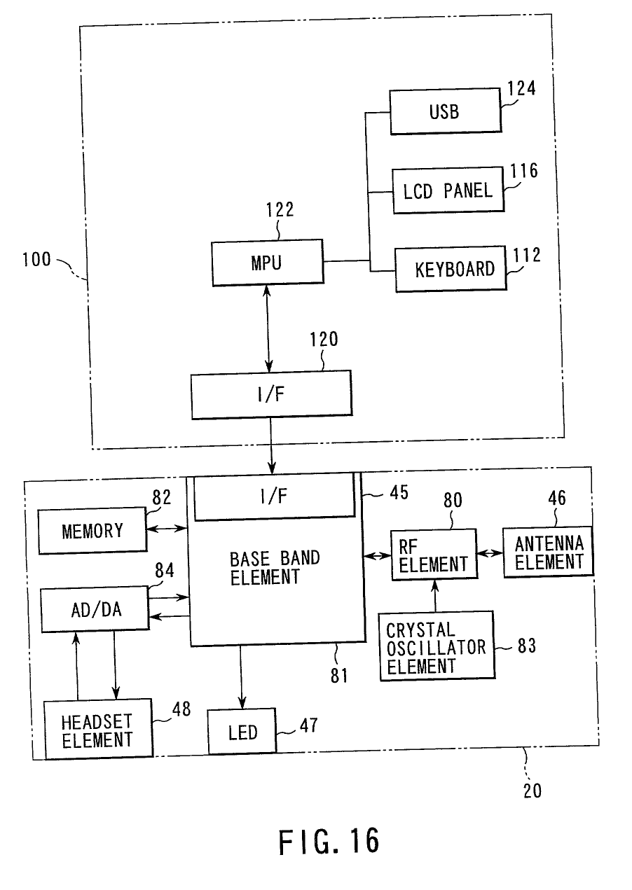

As shown in FIGS. 1 and 16, on the other hand, each personal computer 100 that performs radio communication with the access point 10 comprises a body 114 that is furnished with a keyboard 112 and an openable liquid crystal display panel 116 on the body. The body 114 is provided with a card slot 118, which is removably loaded with another BT-PC card 20. The slot 118 is constructed substantially in the same manner as the card slot 26 of the access point 10, and the BT-PC card 20 is of the same type as the aforesaid one.

Further, the personal computer 100 comprises an interface connector 120 based on the PCMCIA standards and used to transfer data to and from the BT-PC card 20, a MPU 122 for controlling the operations of the connector 120 and the whole computer, and a USB 124 that serves as an interface for function expansion. The USB 124 is used for serial connection to the access point 10 by means of the RS232C connector 22, for example.

According to the access point 10 constructed in this manner, data are transferred between the BT-PC card 20 in the access point and the BT-PC card 20 in the personal computer 100, whereby radio communication of data can be effected between the access point 10 and the personal computer 100 and between a plurality of personal computers 100. If the access point 10 is connected to the public data network by means of the modular cable 12, data wirelessly transmitted from each personal computer 100 can be transferred to the public data network, and data received from the public data network can be wirelessly transmitted to each personal computer 100. Accordingly, there is no need of any cables for connecting the personal computers 100 or modular cables for connecting the computers 100 and the public data network, so that troublesome wire connection and arrangement can be eliminated. Thus, places for the installation of the personal computers 100 can be selected freely, the range of service can be extended, and the operating efficiency can be improved considerably.

According to the access point constructed in this manner, a radio communication card, especially a BT-PC card, is used as a radio module, so that the access point 10 can be improved in versatility and can be wirelessly connected or linked to various apparatuses with ease.

According to the access point described above, moreover, the radio communication card can be used without being influenced by metallic frames that are attached to the apparatus body 14, and a satisfactory distance is secured between the installation surface and the antenna element to ensure steady data communication.

According to the access point 10, as shown in FIG. 6, on the other hand, various operating states of the access point can be set by a user or at the time of shipment or an operator's inspection or maintenance operation in a manner such that shift positions of the slide switches 34a and 34b and the rotary switch 35 on the bottom face 14e of the apparatus body 14 are combined variously.

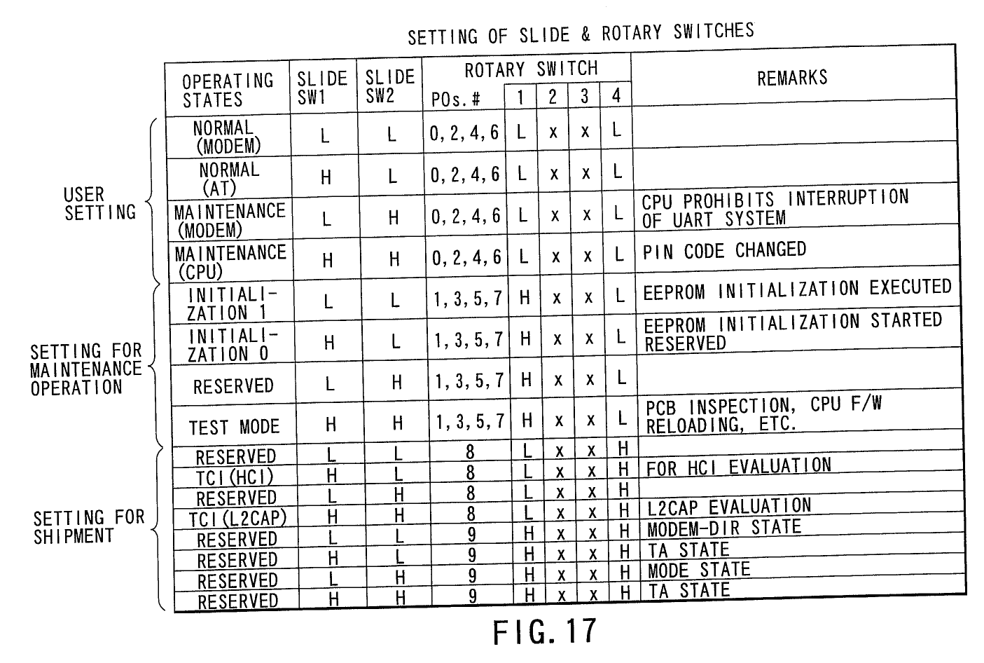

More specifically, each of the slide switches 34a and 34b are can be shifted between two positions L and H, and the rotary switch 35 between ten positions 0 to 9. As shown in FIG. 17, combinations of the shift positions of these switches are assigned individually to predetermined operating states.

Among these operating states, items that are frequently reset by the user, e.g., normal (MODEM), normal (TA), maintenance (MODEM), and maintenance (CPU), can be set alternatively by changing only the respective shift positions of the slide switches 34a and 34b without shifting the rotary switch 35. Thus, the user can easily set these operating states. In the operating state, maintenance (CPU), the PIN code of a BT system can be changed by input operation through the personal computer 100 with the access point 10 and the personal computer connected to each other by means of the RS232C cable.

Further, items related to maintenance and items that are set at the time of shipment are assigned to the operating states that are set by shifting the slide switches 34a and 34b and the rotary switch 35, and the operating states are reset by the operator.

In the access point 10, operating state data that are assigned to the combinations of the respective shift positions of the individual switches are stored in the main memory 74, and the CPU 72 sets the corresponding operating states according to the shift positions of the slide switches 34a and 34b and the rotary switch 35 and the operating state data stored in the main memory.

Thus, the various operating states can be set by shifting only the pair of slide switches 34a and 34b and the one rotary switch 35, so that the operating efficiency can be improved, and the switches can be reduced in number to lower the manufacturing cost. The operating efficiency can be further improved, in particular, since the operating states that are usually frequently reset by the user can be set by shifting the slide switches only.

The present invention is not limited to the embodiment described above, and various changes and modifications may be effected therein by one skilled in the art without departing from the scope or spirit of the invention. According to the foregoing embodiment, for example, the access point is connected to the public data network by means of the transmitter-receiver portion that includes the modular jack and the modem element. However, the object of connection of the access point is not limited to the public data network. More specifically, the access point may be connected to another electronic apparatus so that data can be transferred between the alternative apparatus and each personal computer 100 by radio communication. In this case, the transmitter-receiver portion may be omitted.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a holding portion for detachably holding a radio communication card including an antenna;
a metal plate on which the holding portion is provided; and
a connecting portion for data communication with the radio communication card held by the holding portion,
the holding portion being arranged to hold the radio communication card in a manner such that the antenna is located outside of the holding portion and the minimum distance between the antenna and the metal plate is 1 mm or more.

2. An electronic according to claim 1, which further comprises a transmitter-receiver portion connected to the connecting portion, for transmitting and receiving data through a public data network.

3. An electronic apparatus according to claim 1, wherein the holding portion is arranged to hold the radio communication card in a manner such that the minimum distance between the antenna and the metal plate is 2 mm or more.

4. An electronic apparatus according to claim 1, wherein the radio communication card includes a PC card.

5. An electronic apparatus comprising:
an apparatus body having an installation surface and a first surface opposite to the installation surface;
a holding portion provided at the apparatus body, for detachably holding a radio communication card which has a second surface and an antenna provided on the second surface; and
a connecting portion arranged at the apparatus body, for data communication with the radio communication card held by the holding portion,
the holding portion being arranged to hold the radio communication card in a manner such that the first and second surfaces face in the same direction.

6. An electronic apparatus according to claim 5, wherein the holding portion includes a preventing portion for preventing the radio communication card from being set in a manner such that the first and second surfaces face in opposite directions.

7. An electronic apparatus according to claim 5, which further comprises a transmitter-receiver portion connected to the connecting portion, for transmitting and receiving data through a public data network.

8. An electronic apparatus according to claim 5, wherein the radio communication card includes a PC card.

9. An electronic apparatus according to claim 5, which further comprises a display element provided on the first surface of the apparatus body and capable of displaying operating states.

10. An electronic apparatus comprising:
an apparatus body having an installation surface and a holding portion for detachably holding a radio communication card including an antenna; and
a connecting portion provided at the apparatus body, for data communication with the radio communication card held by the holding portion,
the holding portion being arranged to hold the radio communication card in a manner such that the antenna is located outside of the apparatus body and situated farther from the installation surface of the apparatus body than a center of the apparatus body with respect to the height direction of the apparatus body.

11. An electronic apparatus according to claim 10, which further comprises a transmitter-receiver portion connected to the connecting portion, for transmitting and receiving data through a public data network.

12. An electronic apparatus according to claim 10, wherein the radio communication card includes a PC card.

13. An electronic apparatus comprising:
an apparatus body having a holding portion for detachably holding a radio communication card including an antenna;
a connecting portion provided at the apparatus body, for data communication with the radio communication card held by the holding portion; and
a cover removably fitted to the apparatus body and covering the radio communication card set in position and the holding portion.

14. An electronic apparatus according to claim 13, wherein the apparatus body has an installation surface and a first surface substantially parallel to the installation surface; and the holding portion has a card loading aperture opening in the first surface, and the cover is located covering the card loading aperture and the radio communication card therein.

15. An electronic apparatus according to claim 13, wherein the radio communication card is a PC card.

16. An electronic apparatus according to claim 13, wherein the cover is formed of a nonmetallic material capable of transmitting light.

17. An electronic apparatus comprising:
a holding portion for detachably holding a radio communication card including an antenna;
a connecting portion for data communication with the radio communication card held by the holding portion;
a slide switch;
a rotary switch; and
setting means for setting operating modes of the apparatus in accordance with combinations of shift positions of the slide and rotary switches.

18. An electronic apparatus according to claim 17, which further comprises a transmitter-receiver portion connected to the connecting portion, for transmitting and receiving data through a public data network.

19. An electronic apparatus according to claim 17, which further comprises a radio communication portion involving entry of a specific identification code when linked to another apparatus, and wherein the operating modes including a mode for changing the specific identification code.
